(19) United States
(12) Patent Application Publication
(10) Pub. No.: US 2011/0196750 A1
(43) Pub. Date: Aug. 11, 2011

(54) METHOD AND APPARATUS FOR ONLINE ADVERTISING

(75) Inventor: John Hamill, Co. Monaghan (IE)

(73) Assignee: VENNETICS LIMITED., Co. Louth (IE)

(21) Appl. No.: 12/704,215

(22) Filed: Feb. 11, 2010

(51) Int. Cl. G06Q 30/00; G06F 15/16

(52) U.S. Cl. 705/14.73; 709/206; 705/14.4

(57) ABSTRACT

The present invention provides a method for providing a contact opportunity to a user. The method comprises the steps of storing a list of advertised words, parsing a document for matches with one or more of said advertised words and converting each matched word to a clickable event. The converted document, including the clickable events, is then displayed to the user.

### FIELD OF THE INVENTION

The present invention relates to voice connectivity and Internet based networks, and in particular, to connecting Internet users with advertisers associated with Internet content.

### BACKGROUND TO THE INVENTION

The Internet is changing the world of telecommunications. Traditional telephony networks connect users using a dedicated line and charge for the connection based on the duration and tariff of the call. Usually, the calling party is charged for the call, although services such as toll-free numbers and reverse-charge calling may be provided, whereby the called party is charged. More recently, Internet-based communications services have provided connectivity at low cost, or in some cases at no cost. This type of service is typically provided as a client software application, which is installed on a user's computer or other Web-enabled device, to allow the user to make Voice-over-IP (VoIP) calls to other users of the service and to regular telephone numbers. Usually calls to other users of the service are free of charge, while calls to landlines and cellular networks are charged, generally at a lower cost that a conventional telephone call. Providers of these services fund their services using alternative mechanisms, such as advertising revenue.

At the same time, the Internet has become a major source of information for its users. Most websites, particularly those operated by commercial entities, provide contact information, whereby a user may contact the company by telephone, email, instant message etc. In order to simplify the use of such contact information, and to avail of the free Internet-based communication services discussed above, various click-to-dial solutions that enable a user to establish a telephone call between the user and a telephone number associated with a webpage simply by clicking a link on the webpage, have been proposed. One such solution requires the creator of the website to explicitly associate click-to-dial links with the telephone numbers provided on that website. According to another solution, proposed in US Patent Application Publication No. 2004/0122951, a click-to-contact agent running on a user's client system, or within the network, automatically and uniformly converts all types of contact information embedded in any webpage into click-to-contact links. The user may establish one or two-way telephone or electronic communication with a telephone number or address associated with the webpage by clicking on the click-to-contact link.

Each of these systems allows a user to connect to a company or other entity having a web presence on the basis of contact information provided by the company or entity, where the contact information is actively sought out by the user. It is desirable to provide a system whereby a user may be presented with an opportunity to contact a company that provides a particular good or service which may be of interest to the user, without requiring the user to actively seek contact information for the company.

### SUMMARY OF THE INVENTION

According to an aspect of a present invention, there is provided a method for providing a contact opportunity to a user, comprising the steps of:
storing a list of advertised words;
parsing a document for matches with one or more of said advertised words;
converting each matched word to a clickable event; and
displaying the converted document including the clickable events to the user.

An advantage of this arrangement is that a user may be presented with an opportunity to contact a company that provides a particular good or service which may be of interest to the user, without requiring the user to actively seek contact information for the company.

The document may be a text-based internet document, such as a webpage or an email message. The email message may be a HTML-format email message.

The method may further comprise the step of invoking a connection request to a communications server in response to a user clicking on a clickable event associated with an advertised word. The connection request may be invoked using a web services based protocol. The connection request may contain information identifying the user and the advertised word.

The method may further comprises the steps of:
receiving the connection request at a communications server;
retrieving contact information for the user and for an advertiser associated with the clickable event clicked by the user; and
establishing a voice connection between the user and the advertiser.

Advantageously for the user, the advertiser may accept the cost of this voice connection.

The method may further comprise the steps of:
associating one or more advertised words with an advertiser; and
storing contact information, and optionally, location information for the advertiser.

The method may further comprise storing contact information, and optionally, location information for the user.

According to another aspect of the present invention, there is provided a client application comprising:
means for storing a list of advertised words;
means for parsing a document for matches with one or more advertised words;
means for converting each matched word to a clickable event; and
means for displaying the converted document including the clickable events to a user.

The client application may further comprise means for invoking a connection request to a communications server in response to a user clicking on a clickable event associated with an advertised word.

According to a further aspect of the present invention, there is provided a server application, comprising:
means for storing contact information for a user and an advertiser and for associating an advertised word with an advertiser;
means for receiving a connection request from a client application in response to a user clicking on a clickable event associated with an advertised word;
means for retrieving contact information for the user from which the connection request originated and for an advertiser associated with the advertised word clicked by the user; and
means for establishing a voice connection between the user and the advertiser.

According to yet another aspect of the invention, there is provided a system comprising:
a client application provided on a web-enabled user device, wherein the client application provides the user with at least one clickable event and wherein the clickable event is associated with an advertised word;
a server application provided on a server, wherein the server application associates the advertised word with an advertiser;
a user communication device; and
an advertiser communication device;
wherein the user device, the server, the user communication device and the advertiser communication device are connected to one another through a network; and
wherein voice communication is established between the user communication device and the advertiser communication device by the server in response to a connection request invoked by the user by clicking on the clickable event.

### BRIEF DESCRIPTION OF THE DRAWINGS

FIG. 1 is a schematic representation of a system according to an embodiment of the present invention;

FIG. 2 is a block diagram of a server application according to an embodiment of the present invention;

FIG. 3 is a flow chart representing a method according to an embodiment of the present invention; and

FIG. 4 is a flow chart representing steps of a method according to an embodiment of the present invention.

### DETAILED DESCRIPTION OF THE DRAWINGS

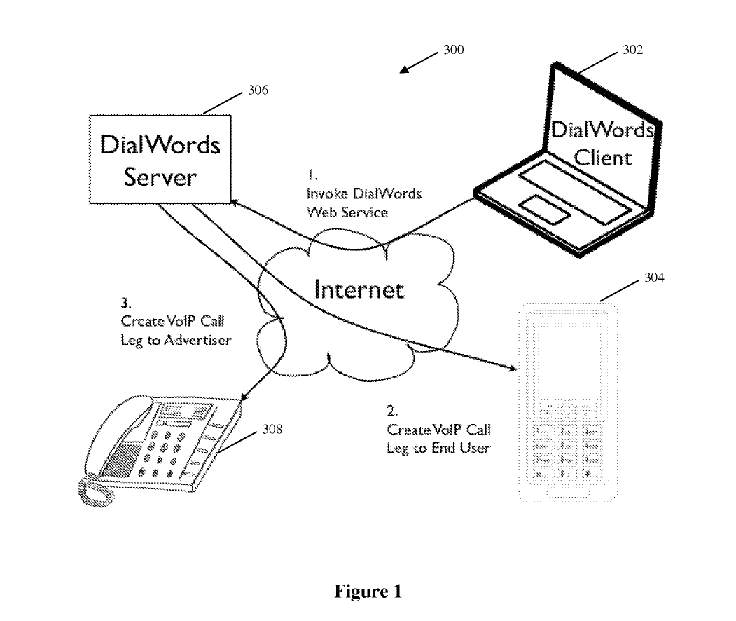

Referring to FIG. 1, there is illustrated a system 300 according to the present invention. The system 300 comprises a user computer or other web-enabled device 302, on which a DialWords client application is installed. The system also comprises a user communication device, such as a telephone 304. The system further comprises a DialWords server 306 and an advertiser communication device or telephone 308. The various elements of the system are connected by way of the Internet. As will be described in more detail below, a web service connection request is invoked by the user and sent from the user's computer 302 to the DialWords server 306. The DialWords server sets up a first VoIP call leg to the advertiser's telephone 308 and a second VoIP call leg to the user's telephone 304, thereby establishing voice communication between the user and the advertiser.

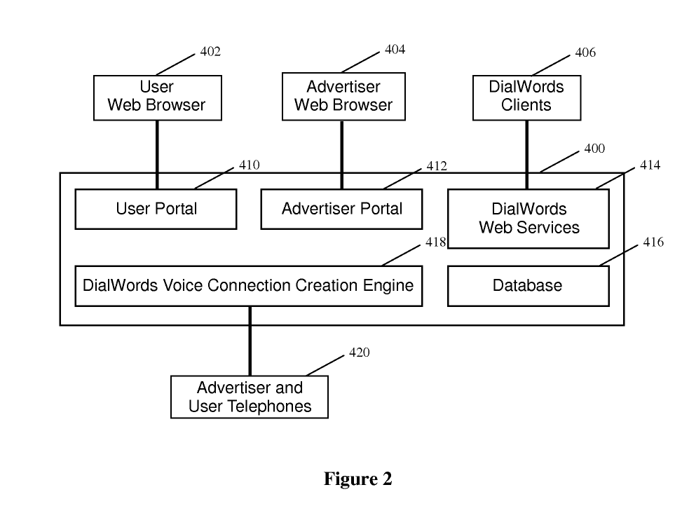

Referring to FIG. 2, there is illustrated a server application 400, hereinafter referred to as a DialWords server, according to an aspect of the present invention. The DialWords server 400 comprises a web-based advertiser portal 412 which allows advertisers to create and update an advertiser profile via a web browser 404. The profile is stored in the database 416 and includes contact and, optionally, location information for the advertiser, as well as the advertised words associated with the advertiser. The contact information may include at least one telephone number. The advertiser may use the portal 412 to update his profile, for example, by adding new advertised words, removing existing advertised words or by changing the location or contact information stored in the database 416.

The DialWords server 400 also comprises a user portal 410. The user portal 410 allows users to sign up for the DialWords service via a web browser 402 and to create a user profile comprising contact and, optionally, location information. The user profile is stored in the database 416. The user portal 410 also allows users to update an existing profile, for example, by changing the telephone number or location stored in the database 416.

The server 400 further comprises a DialWords web services module 414. The web services module 414 provides the capability to update DialWords client applications 406 installed on users' computers or other web-enabled devices. Updates are performed using a web services based protocol. The web services module 414 also accepts web service invocations from DialWords clients 406 using the same protocol.

The server 400 also comprises a voice connection creation engine 418. The voice connection creation engine retrieves user data and advertiser data stored in the database 416 in response to a connection request or web service invocation received by web services module 414 and creates the appropriate voice connection between the user and advertiser telephone 420.

The system is set up by allowing advertisers to select words with which to be associated. For example, a clothing retailer might choose to be associated with the words “dress” or “sweater”. A dental practice might choose to be associated with the words “dentist” or “teeth”. A garden centre might choose to be associated with the words “patio” or “plant”.

Once an advertiser has selected the word or words with which it wishes to be associated, the advertiser uses the web-based advertiser portal 412 to create an advertiser profile. The advertiser registers the selected words, which are then considered “advertised words”. The advertiser also registers contact details, including a telephone number. This information is stored in the advertiser profile in the database 416. Location information may also be registered and stored in the advertiser's profile. For example, the advertiser may only wish to advertise to users within a specific radius of the advertised business. This allows advertised words to be re-used on a geographical basis. Payment details, such as a credit card number, may also be stored in the advertiser profile.

A user may register for the DialWords service by installing the DialWords client 406 on his computer or other web-enabled device, and using the web-based user portal 410 to create a user profile. The user profile comprises contact information for the user, including a telephone number and is stored in the database 416. The user may also register location information so that he receives advertisements for local businesses. The DialWords client 406 then downloads a list of current advertised words for the user's registered location from the database 416 via the web services module 414. This list may include local advertised words, that is, advertised words registered specifically for the user's location. It may also include global advertised words, that is, words which are registered for more than one location, or for all locations. The list of advertised words stored at the DialWords client may be periodically updated by the DialWords server via the web services module 414. For example, each time a new advertised word is registered, or an existing advertised word is removed or expires, all DialWords clients, or all clients in the relevant locations, may be updated accordingly. This ensures that all clients have the most up-to-date list of advertised words.

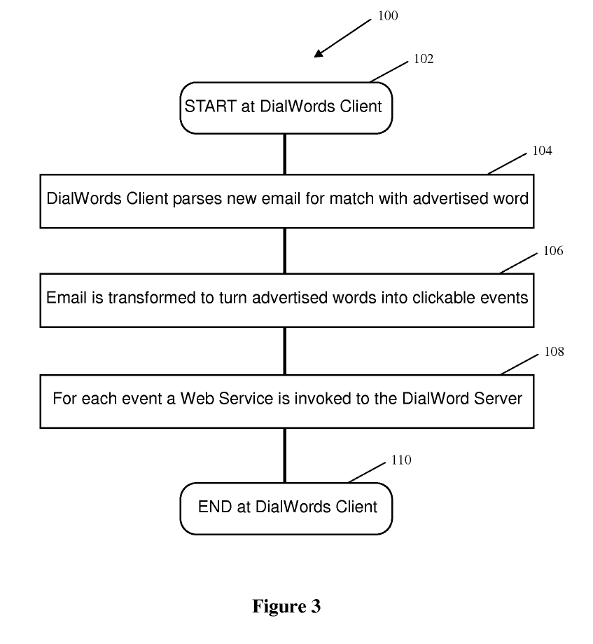

FIG. 3 illustrates a method 100 for providing a contact opportunity to a user according to an embodiment of the present invention. The method starts at the DialWords client 406 at step 102. At step 104, when an email is received by a user (or a webpage is requested from a server), the DialWords client application 406 parses the email (or webpage) for matches with one or more advertised words on the list stored at the DialWords client. At step 106, the email (or webpage) is transformed by replacing each text-based instance of the matched advertised word in the document to a clickable event. Thus, as per the examples set out above, should the word “teeth” appear in the email, the word is converted to a clickable event, whereby clicking on the word “teeth” will cause the user to be connected to a local dentist. The transformed email document including the clickable events is then displayed to the user. In step 108, when a user clicks on one of the clickable DialWords events, a Web Service invocation corresponding to this event is made to the DialWords server 400.

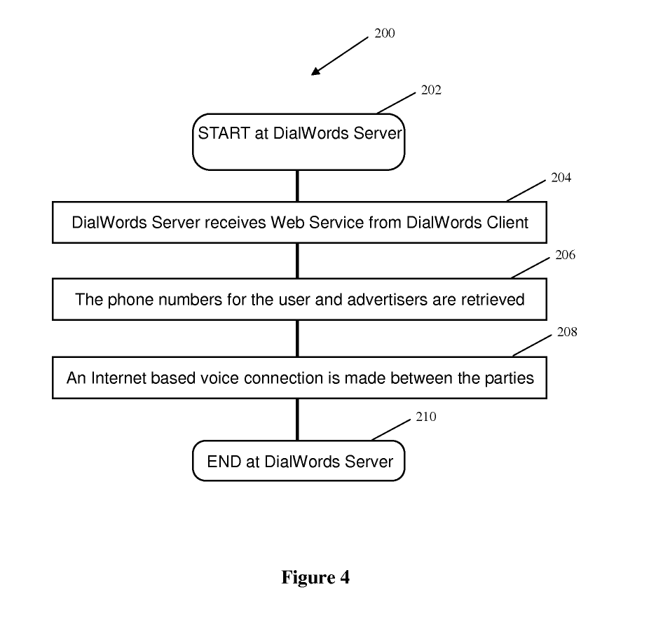

FIG. 4 illustrates further steps of a method 200 according to an embodiment of the invention. The method starts at the DialWords server 400 at step 202. At step 204, the DialWords server 400 receives the web service invocation (connection request) from the DialWords client. The web services invocation includes information identifying the user and the advertised word corresponding to the DialWords event which triggered the invocation. At step 206, contact information, such as telephone numbers, is retrieved from the user profile and from the advertiser profile (corresponding to the advertised word identified in the web services invocation) stored in database 416. At step 208, an Internet-based voice connection is established between the user and the advertiser. The DialWords server first creates a voice connection over the Internet to the user's telephone 304, as shown in FIG. 1. When the user answers the call, a recorded announcement is played to indicate that the call relates to the DialWords service invoked by clicking on the advertised word. The DialWords server then creates a second voice call leg to the advertiser. Once the advertiser answers the call, a connection is established between the advertiser and the user via the DialWords server 400.

Thus, the user experience enabled by the present invention is that, on registering for the DialWords service, specific words within emails and webpages will become clickable events for the user. On clicking on one of these words, an Internet-based voice (VoIP) call is established between the user and an advertiser associated with the clicked word. Advantageously for the user, the advertiser accepts the cost of this voice call. The advertiser may also pay the DialWords service operator on a per word and/or a per location basis. The benefit of the service to advertiser is that contact opportunities are provided to users, at the moment when they are considering a particular good or service, without requiring the user to actively seek contact information for a business related to that good or service.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium is coupled to the processor such the processor may read information from, and write information to, the storage medium. In the alternative, the storage medium may be integral to the processor. The processor and the storage medium may reside in an ASIC.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method for providing a contact opportunity to a user, comprising the steps of:
storing a list of advertised words;
parsing a document for matches with one or more of said advertised words;
converting each matched word to a clickable event; and
displaying the converted document including the clickable events to the user.

2. A method as claimed in claim 1, wherein the document is a text-based internet document.

3. A method as claimed in claim 2, wherein the document is a webpage or an email message.

4. A method as claimed in claim 3, wherein the email message is a HTML-format email message.

5. A method as claimed in claim 1, further comprising the step of:
invoking a connection request to a communications server in response to a user clicking on a clickable event associated with an advertised word.

6. A method as claimed in claim 5, wherein the connection request is invoked using a web services based protocol.

7. A method as claimed in claim 5, further comprising the steps of:
receiving the connection request at a communications server;
retrieving contact information for the user and for an advertiser associated with the clickable event clicked by the user; and
establishing a voice connection between the user and the advertiser.

8. A method as claimed in claim 5, wherein the connection request contains information identifying the user and the advertised word.

9. A method as claimed in claim 1, further comprising the steps of:
associating one or more advertised words with an advertiser; and
storing contact information for the advertiser.

10. A method as claimed in claim 7, further comprising the step of:
storing location information for the advertiser.

11. A method as claimed in claim 1, further comprising storing contact information for the user.

12. A method as claimed in claim 1, further comprising storing location information for the user.

13. A client application comprising:
means for storing a list of advertised words;
means for parsing a document for matches with one or more advertised words;
means for converting each matched word to a clickable event; and
means for displaying the converted document including the clickable events to a user.

14. A client application as claimed in claim 11, wherein the document is a text-based internet document.

15. A client application as claimed in claim 12, wherein the document is a webpage or an email message.

16. A client application as claimed in claim 13, wherein the email message is a HTML-format email message.

17. A client application as claimed in claim 11, further comprising:
means for invoking a connection request to a communications server in response to a user clicking on a clickable event associated with an advertised word.

18. A server application, comprising:
means for storing contact information for a user and an advertiser and for associating an advertised word with an advertiser;
means for receiving a connection request from a client application in response to a user clicking on a clickable event associated with an advertised word;
means for retrieving contact information for the user from which the connection request originated and for an advertiser associated with the advertised word clicked by the user; and
means for establishing a voice connection between the user and the advertiser.

19. A system comprising:
a client application provided on a web-enabled user device, wherein the client application provides the user with at least one clickable event and wherein the clickable event is associated with an advertised word;
a server application provided on a server, wherein the server application associates the advertised word with an advertiser;
a user communication device; and
an advertiser communication device;
wherein the user device, the server, the user communication device and the advertiser communication device are connected to one another through a network; and
wherein voice communication is established between the user communication device and the advertiser communication device by the server in response to a connection request invoked by the user by clicking on the clickable event.

20. Computer readable media embodying a program of instructions executable by a computer program to perform a method for providing a contact opportunity to a user, the method comprising:
storing a list of advertised words;
parsing a document for matches with one or more of said advertised words;
converting each matched word to a clickable event; and
displaying the converted document including the clickable events to the user.
